(19) United States
(12) Patent Application Publication
(10) Pub. No.: US 2025/0054202 A1
(43) Pub. Date: Feb. 13, 2025

(54) PRIORITIZING USERS IN AN AUGMENTED REALITY ENVIRONMENT BY CONTEXT

(71) Applicant: THE WEATHER COMPANY, LLC, Brookhaven, GA (US)

(72) Inventors: Cindy Han Lu, San Jose, CA (US); Dain Ryoo, Austin, TX (US); Thai Quoc Tran, San Jose, CA (US); Weiwei Liu, Irvine, CA (US)

(21) Appl. No.: 18/446,092

(22) Filed: Aug. 8, 2023

(51) Int. Cl. G06T 11/00; G06V 20/20; G06V 20/50

(52) U.S. Cl. CPC G06T 11/00; G06V 20/20; G06V 20/50

(57) ABSTRACT

Techniques are described with respect to a system, method, and computer program product for prioritizing users in a virtual environment. An associated method includes analyzing a virtual environment; determining a context of a plurality of users associated with the virtual environment; ranking each user of the plurality of users based on the analysis and the context; and visualizing the plurality of users in a prioritized depiction within the virtual environment based on the ranking.

### FIELD

This disclosure relates generally to virtual and augmented reality visualizations, and more particularly to computing systems, computer-implemented methods, and computer program products configured to prioritize users in an augmented reality environment by context.

### BACKGROUND

Virtual, augmented, mixed, and extended reality encompasses the visualization of virtual environments in which physical and digital objects co-exist allowing users represented as avatars to virtually interact with the virtual environments along with their components. However, these virtual environments are shared across multiple users operating over networks resulting in a lack of affinity among users with personal and/or social connections. For example, a virtual event hosted in a virtual venue (e.g., virtual concert, E-sport, etc.) includes multiple users simultaneously viewing the event but also having the ability to view other attendees at the virtual event. Thus, privacy and applicable grouping in virtual environments established based on the context of a virtual environment and/or social connections among users in the virtual environment is necessary.

### SUMMARY

Additional aspects and/or advantages will be set forth in part in the description which follows and, in part, will be apparent from the description, or may be learned by practice of the invention.

Aspects of an embodiment of the present invention disclose a method, system, and computer program product for prioritizing users in a virtual environment. In some embodiments, the computer-implemented method for prioritizing users in a virtual environment comprises analyzing a virtual environment; determining a context of a plurality of users associated with the virtual environment; ranking each user of the plurality of users based on the analysis and the context; and visualizing the plurality of users in a prioritized depiction within the virtual environment based on the ranking.

In some aspects of an embodiment of the present invention, virtual environments are able to be analyzed and modified in order to not only ascertain the amount of computational resources necessary to visualize the plurality of users in the virtual environment based on the ranking, but also to modify presentation to users in the virtual environment among each other subject to the respective perspectives of the users.

In some aspects of an embodiment of the present invention, the analyses of virtual environments allow contextual information to be ascertained. The contextual information assists with the identification of context-based virtual objects that trigger shared memories amongst users within the virtual environments being analyzed. Upon detection of one or more context-based virtual objects, a context-based virtual experience shared between users in the virtual environment may be initiated.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a virtual environment analysis and grouping allocation system environment, according to an exemplary embodiment;

FIG. 3 illustrates a block diagram of a virtual environment analyzer module and a grouping allocation module of FIG. 2, according to an exemplary embodiment;

FIG. 4 illustrates a virtual event within a virtual environment including multiple users depicted according to ranking allocated by the grouping allocation module of FIG. 3, according to an exemplary embodiment;

FIG. 5 illustrates a virtual collaboration within a virtual environment including multiple users depicted according to ranking allocated by the grouping allocation module of FIG. 3, according to an exemplary embodiment; and

FIG. 6 illustrates an exemplary flowchart depicting a method for prioritizing users in a virtual environment, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for prioritizing users in a virtual environment. Virtual, augmented, mixed, and extended reality involves user perception of a real-world environment through superimposition of a digital overlay; however, privacy within generated virtual environments is a concern due to the fact that the systems collect and present information associated with users within said environments. For example, the presence of a user's virtual avatar within a virtual environment allows other users within the same environment to know the user is present even during instances when it is not desired. With the rampant popularity of social media platforms, social networking and business connections have started to be used as a mechanism to tailor gatherings of users, and with the addition of VR/AR technology, social and business networks may be utilized as a filtration mechanism for the visualization of users within virtual environments. In light of the privacy concerns, users may not always desire to make their presence known in virtual environments. For example, a user attending a social virtual event (e.g., a virtual concert) may not desire their attendance be known to their co-workers attending the same social virtual event and vice-versa. In another example, a manager may not wish to make their presence known to their subordinates participating in a virtual collaborative session hosted within a virtual environment in order to ensure productivity is consistent when the manager is not present. Thus, the present embodiments have the capacity to not only improve the VR/AR experience by integrating social and business networks, but also optimize privacy within virtual environments by concealing the presence of a user from other users in virtual environments based on their respective relationships derived from their social/business network in a manner that is not significantly demanding on computing resources.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As described herein, virtual reality (“VR”) refers to a computing environment configured to support computer-generated objects and computer mediated reality incorporating visual, auditory, and other forms of sensory feedback. It should be noted that a VR environment may be provided by any applicable computing device(s) configured to support a VR, augmented reality, and/or mixed reality user interacting with their surroundings, said interactions including but not limited to user movement/gazing, manipulation of virtual and non-virtual objects, or any other applicable interactions between users and computing devices known to those of ordinary skill in the art.

As described herein, augmented reality is technology that enables enhancement of user perception of a real-world environment through superimposition of a digital overlay in a display interface providing a view of such environment. Augmented reality enables display of digital elements to highlight or otherwise annotate specific features of the physical world based upon data collection and analysis. For instance, augmented reality can provide respective visualizations of various layers of information relevant to displayed real-world scenes.

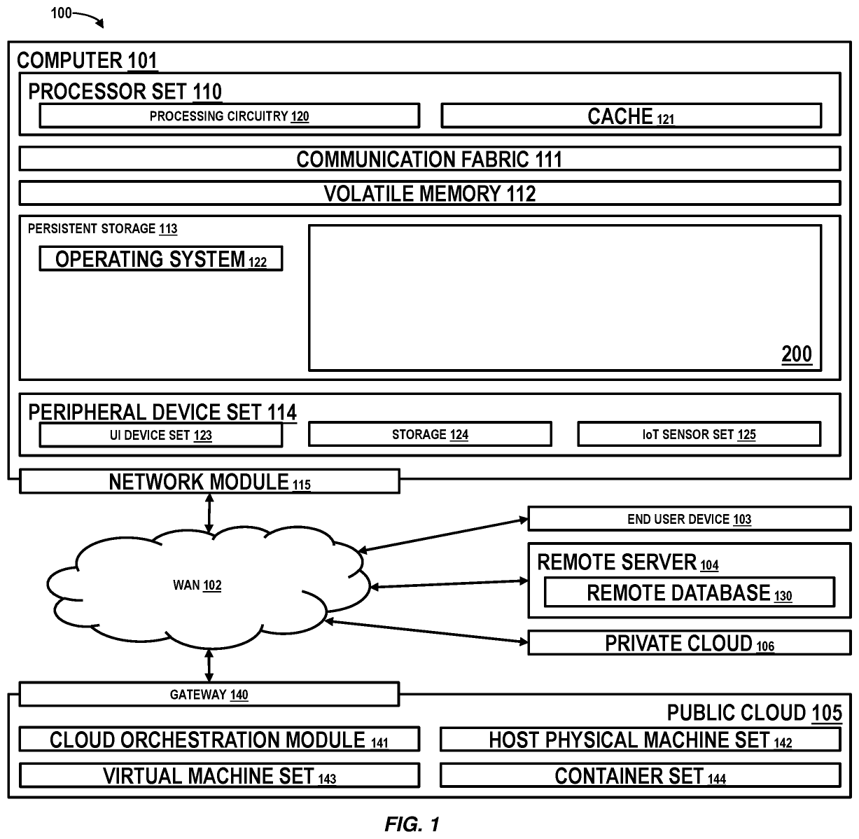

The following described exemplary embodiments provide a system, method, and computer program product for prioritizing users in a virtual environment. Referring now to FIG. 1, a computing environment 100 contains an example of an environment for the execution of at least some of the computer code involved in performing the inventive methods, such as system 200. In addition to system 200, computing environment 100 contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

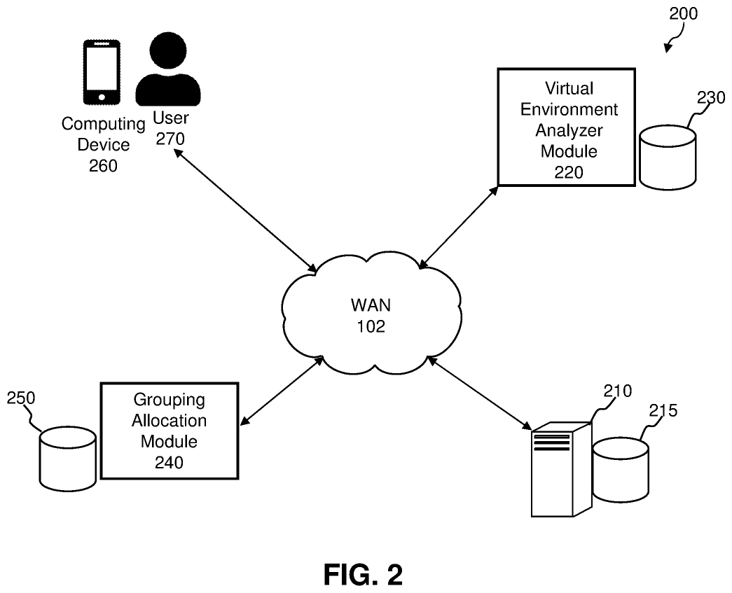

Referring now to FIG. 2, a functional block diagram of a networked computer environment illustrating a computing environment for prioritizing users in a virtual environment system 200 (hereinafter “system”) comprising a server 210 communicatively coupled to a database 215, a virtual environment analyzer 220, a virtual environment analyzer database 230, a grouping allocation module 240, a grouping allocation module database 250, and a computing device 260 associated with a user 270, each of which are communicatively coupled over WAN 102 (hereinafter “network”) and data from the components of system 200 transmitted across the network is stored in database 215. In some embodiments, server 210 is configured to operate a centralized platform serving as a cloud-based user prioritizing and visualizing mechanism within virtual/augmented reality environments. Server 210 is configured to provide a mechanism for user 270 to provide user inputs and establish preferences, privacy settings, and the like via accessing one or more user interfaces and application programming interfaces (APIs) provided to computing device 260.

In some embodiments, the centralized platform is configured to enable user 270 to not only view rankings respective to user 270 pertaining to other users within the applicable virtual environment, but also to establish their preferences, such as visibility to other users within the virtual environment along with how other users are visualized from their perspective based on the social/business networks associated with user 270. For example, server 210 is configured to communicate with applicable social and business networking platforms in order to ascertain social and business connections of user 270 and other users in the applicable virtual environment accordingly. It should be noted that indicators may be allocated to users within the virtual environment based on the social and business networks of user 270. For example, users in the virtual environment that have a social connection with user 270 may be presented as highlighted and users who are not social connections but have mutual connections with user 270 may be depicted with a flashing effect applied to the applicable avatar in the virtual environment. Flashing, shadowing, highlighting, and any other applicable virtual environment indicators known to those of ordinary skill in the art may be utilized to execute the aforementioned feature. The centralized platform also provides a mechanism that allows user 270 to establish a privacy room within a virtual environment such as a virtual collaboration or virtual event, in which social and/or business connections designated by user 270 are concealed from other users in the virtual environment resulting in the presence of the avatars associated with user 270 and the designated individuals being undetectable within the virtual environment.

Virtual environment analyzer 220 is configured to survey virtual environments in order to ascertain information associated with the virtual environment such as, but not limited to, contextual information, computational/bandwidth requirements, virtual objects/elements, type of virtual environment, geographic data, spatial/temporal data, or any other applicable ascertainable information associated with a virtual environment or digital space known to those of ordinary skill in the art. The data that is processed and analyzed by virtual environment analyzer module 220 is configured to be stored in virtual environment analyzer module database 230, in which virtual environment analyzer module database 230 is designed to function as a repository continuously updated with not only data ascertained by analyses performed by virtual environment analyzer module 220, but also other applicable data sources including, but not limited to, crowdsourcing platforms, internet based data sources ascertained by web crawlers (e.g., social media platforms, business networking platforms, etc.), inputs of user 270 provided to the centralized platform, and the like. In some embodiments, contextual factors, parameters, and/or user preferences such as, for example, current weather conditions, a geographical location, physical features and styling, likes and dislikes, user's purchases and/or interests, and the like may be accounted for in virtual environment analyzer module database 230. As described herein, contextual information may include, but is not limited to, user location, topic/subject matter, date/time, environment/virtual object theme/setting, a participant threshold of user 270 associated with the virtual interactions in the virtual environment (e.g., dialogue, interactions with virtual elements, etc.), type of virtual event occurring within the virtual environment (e.g., E-sport, virtual concert, dining experience, shopping experience, etc.), occurrences of a predetermined pattern of content or activity within the event, or any other applicable contextual-based data known to those of ordinary skill in the art. Virtual environment analyzer module 220 may further utilize one or more techniques to analyze virtual environments including, but not limited to, natural language processing (NLP), image analysis, topic identification, virtual object recognition, setting/environment classification, and any other applicable artificial intelligence and/or cognitive-based techniques known to those of ordinary skill in the art. Virtual environment analyzer module 220 is further tasked with providing techniques that facilitate automatic, reliable performance of a point cloud object-environment segmentation task in order to analyze virtual environments. For example, virtual environment analyzer 220 may provide the capability to perform automatic segmentation of a 3D point cloud into object and virtual environment segments by progressively learning the object-environment segmentation from tracking sessions in augmented reality (AR) applications associated with the centralized platform. In some embodiments, segmenting of the virtual environment allows virtual environment analyzer 220 to ascertain not only the context associated with a virtual environment, but also the bandwidth necessary for users to be visualized in the virtual environment in accordance with the rankings derived from the analyzed social network graph of user 270.

Grouping allocation module 240 is tasked with maintaining user profiles along with analyzing social and business networks associated with user 270 in order to render vectors generated based on the analysis of social graphs derived from the user profile. The user profiles are ascertained from social network profiles associated with user 270 in addition to any other applicable profile associated with user 270 in which preferences, interests, skillsets, activities, affiliations, demographic data, and the like can be ascertained. In some embodiments, the vectors represent relationships among user 270 and users within the applicable virtual environment across a plurality of categories, in which user 270 provides a priority to the relationship (e.g., work relationship, social relationship, etc.), therefore, tailoring how users are visualized within the virtual environment. The priority may be established by a user input of user 270 provided to the centralized platform and/or an output of one or more machine learning models trained on datasets derived from the user profile. For example, if virtual environment analyzer module 220 is able to ascertain that the virtual environment is a social virtual event and historically user 270 prefers to avoid interactions with co-workers and/or individuals that they have a business connection with in these type of environments, then grouping allocation module 240 may predict that users who share a business relationship and/or mutual business relationship may be concealed in the virtual environment for user 270 and vice versa. Grouping allocation module 240 is further configured to allocate prioritization to social and business connections associated with user 270 based on social network graphs generated by grouping allocation module 240. The social network graphs indicate relationships between the users based on the user profiles. In some embodiments, the social network graphs are utilized to construct matrices including multi-dimensional weights calculated for user 270 as a vector within a plurality of categories (e.g., work, school, social, etc.). The vectors are stored in grouping allocation module database 250 and continuously updated resulting in the accuracy of the rankings of users according to user 270 being maintained.

Computing device 260 may take the form of a desktop computer, laptop computer, tablet computer, smart phone, smart watch or other wearable computer, mainframe computer, computer-mediated reality (CMR) device/VR device, quantum computer or any other form of computer or mobile device now known or to be developed in the future that is capable of running a program, accessing a network, or querying a database. It should be noted that in the instance in which computing device 260 is a CMR device (e.g., VR headset, AR goggles, smart glasses, etc.) or other applicable wearable device, computing device 260 is configured to collect sensor data via one or more associated sensor systems including, but are not limited to, cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a radar sensor, a LiDAR sensor, a temperature sensor, a humidity sensor, a motion sensor, internet-of-things (“IoT”) sensors, or any other applicable type of sensors known to those of ordinary skill in the art.

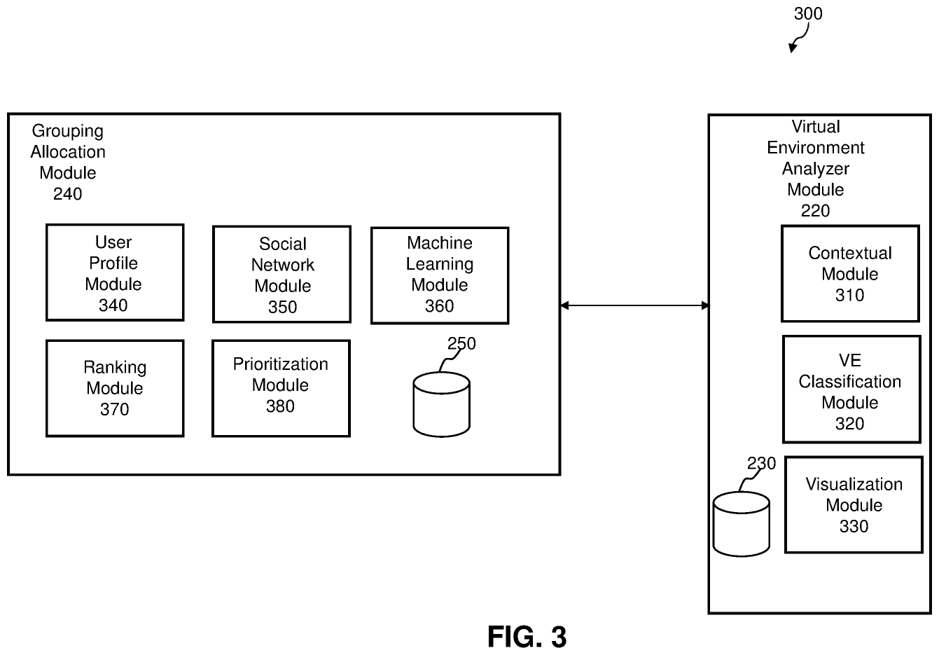

Referring now to FIG. 3, an example architecture 300 of virtual environment analyzer module 220 and grouping allocation module 240 is depicted, according to an exemplary embodiment. Virtual environment analyzer module 220 comprises a contextual module 310, a virtual environment classification module 320, and a visualization module 330. Grouping allocation module 240 comprises a user profile module 340, a social network module 350, a machine learning module 360, and a ranking module 370.

Contextual module 310 is designed to determine the context of a virtual environment, in which the context may be established by one or more of analyses of virtual environment elements (e.g., setting, theme, virtual objects, etc.), relationships between users within the virtual environment (e.g., multiple co-workers indicating a work related virtual event), detected geographic location or virtual environment location of user 270, and the like. For example, contextual module 310 may detect a large virtual venue, a musician, virtual instruments, etc. resulting in contextual module 310 ascertaining the context that the virtual environment is a virtual concert. Furthermore, contextual module 310 is further configured to trigger context-based virtual experiences for user 270 and users within the virtual environment that they have a relationship with. In some embodiments, the ascertained contextual information assists with the identification of context-based virtual objects that trigger shared memories amongst users within the virtual environments being analyzed. Upon detection of one or more context-based virtual objects, a context-based virtual experience shared between users in the virtual environment may be initiated. For example, a stuffed toy montage may be detected within the virtual environment, in which user 270 and their sister used to collect stuffed toys so detection of these virtual object triggers a “shared experience” within the virtual environment based on the ascertained contextual information.

Virtual environment classification module 320 is tasked with classifying virtual environments along with virtual elements within virtual environments. As described herein, virtual elements may include, but are not limited to, virtual objects, virtual actions, image, video, sound, resource requirements, or any other applicable virtual/augmented/mixed/extended reality-based elements designed to support interactions with users known to those of ordinary skill in the art. VE classification module 320 is further configured to perform classification and categorization of the aforementioned along with one or more extracted features associated with virtual environments such as intent, entities, emotions, etc. in a manner that supports segmenting, tagging of metadata, and classification techniques such as, but not limited to, probabilistic classification, Bayes classification, binary classification, linear classification, hierarchical classification, and the like. For example, VE classification module 320 may classify the virtual concert as a social virtual event resulting in the prediction that user 270 would only wish to have social connections depicted in the virtual environment (i.e., concealing business connections in the virtual environment if applicable). In some embodiments, VE classification module 320 may classify objects within live video feeds presented to computing device 260, in which the objects may be highlighted and/or annotated within the virtual environment, and determine points of interest or key focal points for the purpose of distinguishing physical structures, virtual objects, friends of user 270, co-workers of user 270, mutual connections of user 270, etc. within the virtual environment. VE classification module 320 may further support historical mapping of placement and positioning of virtual elements within the virtual environment based on historical mappings of virtual environments stored within virtual environment analyzer module database 230.

Visualization module 330 is tasked with visualizing users within the virtual environment for the depiction to user 270 via computing device 260. In addition, visualization module 330 is configured to generate visual barricades that cooperate to define the privacy rooms within the virtual environment allowing users within the privacy rooms to not be visible to those outside the visual barricade. The visual barricades prevent users in the virtual environment that user 270 does not wish to be seen by from being able to view the portion of the virtual environment where the privacy room has been established. Visual barricades may be presented with a blurring effect, mirroring effect, silhouette effect, opaque effect, etc. overlaid on user 270 and other users that user 270 designates for the privacy room. It should be noted that visualizations of the virtual environment and its components are rendered to user 270 in a manner in which spatial and temporal information are taken into consideration; thus, other users are not able to view the same content as user 270 preserving privacy. Techniques such as caching of content (e.g., visual barricades, privacy rooms, etc.) at various hub points are within the spirit of the disclosure. For example, visual barricades and privacy rooms may be visible to targeted users (e.g., user 270 and their designated connections in the virtual environment) allowing presentation of content to others in the virtual environment to go undisrupted.

User profile module 340 is configured to generate a user profile associated with user 270 and other applicable users in the virtual environments. The user profile is designed to indicate social connections, business connections/relationships, interests, topics of expertise, social media activity, browsing patterns, user analytics, preferences, and the like, in which the user profile is stored on grouping allocation module 240. User profiles may further function as aggregations of user data associated with user 270 including, but not limited to, personal information, biological data, behavioral data, socio-demographic data, psychographic data, and the like continuously being updated via applicable data being received from one or more of server 210, computing device 260, and any other applicable data sources. In some embodiments, user profiles may be obtained from social media sources, resumes, etc. and users preferred by user 270 may be designated based on frequently interacted with contacts, nature of the relationship between user 270 and the particular user, and the like.

Social network module 350 is tasked with generating the social network graphs based on analyzing the user profiles, in which the social network graphs indicate relationships between user 270 and other users. Social network module 350 manages a series of users and relationships between those users as nodes (representing the users) and edges connecting the nodes (representing the relationships). In some embodiments, each node may include information about the user represented by that node, including, but not limited to: name, age, gender, geographic location/domicile, organization/affiliation, work title, contact information, privacy preferences, and the like. Each edge may include information about the relationship represented by that node, including, but not limited to: a type of relationship (kinship/friendship/professional), a duration of the relationship, a source of the relationship (e.g., pulled from applicable social network platform(s), pulled from a telecommunication platforms (e.g., virtual collaboration software, email providers, internal enterprise module), strength of the relationship (e.g., a frequency of communication), and any other applicable relationship factor known to those of ordinary skill in the art. In the constructed vectors, two users having similar user profiles have a proximate vector (i.e., less cosine similarity score); however, various embodiments support vector/embedding clustering techniques and other applicable techniques known to those of ordinary skill in the art. In some embodiments, Manhattan distance is calculated between vectors in order to ascertain proximity of relationships between users.

Machine learning module 360 is configured to use one or more heuristics and/or machine learning models for performing one or more of the various aspects as described herein. In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, Siamese network (“twin neural network”), long short-term memory (LSTM), convolutional neural network (CNN), recursive neural network (RNN), sequence-to-sequence model, shallow neural network, multilayer perceptron (MLP), back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure. In particular, machine learning module 360 is configured to operate and maintain one or more machine learning models configured to utilized training datasets derived from database 215, virtual environment analyzer module database 230, grouping allocation module database 250, and any other applicable data source, in which the one or more machine learning models are configured to generate outputs representing predictions of relationship and mutual connections relative to user 270. Another major purpose of machine learning module 360 is to assist with the generation of the vectors based on the user profiles, in which the output value of the one or more machine learning models is within a range [0, 1], wherein “0” indicates a user does not have a relationship with user 270, while “1” indicates a user has a relationship with user 270. If the output value is over a predefined threshold, e.g., “0.7,” then the user has a relationship with user 270. The calculation of the multi-dimensional weights allows ranking of users in the virtual environment to occur. For example, user 270 wants to attend a virtual concert with friends who are geographically close, in which the applicable vector will comprise two dimensions (i.e., <friendship, distance>).

In some embodiments, the one or more machine learning models may initiate one or more feedback loops in order to optimize the context associated with a virtual environment derived from contextual module 310. In some embodiments, the contextual information may be ascertained by the one or more machine learning models are trained at initialization and/or through the use of the feedback loop to weight the features ascertained from the analyzing of the virtual environment such that features shown to have a greater correlation with user 270 based on context are weighted greater than those features that are not.

Ranking module 370 is tasked with utilizing the vectors derived from the social network graphs to generate rankings of users in relation to user 270. It should be noted that rankings may be based on a various factors including, but not limited to, frequency of communication with user 270 across applicable platforms (e.g., email, text, gaming, etc.) and nature of the relationship with user 270 (e.g., boss, best friend, relative, co-worker, etc.). As a result of the ranking, visualization module 330 determines which users are concealed in relation to user 270 and vice-versa, in which the presentation of a particular user to user 270 in the virtual environment is subject to the determined relationship with user 270 derived from the user profile along with the ascertained contextual information. For example, in a social virtual event only the close friends of user 270 may be depicted to user 270 within the virtual environment.

Prioritization module 380 is configured to render vectors based on the social network graphs, in which each vector has a calculated multi-dimensional weight for each user within a plurality of categories. In some embodiments, prioritization module 380 is configured to recommend a top N (e.g., top 10) users to user 270 based on analysis of the user profile in which N is a pre-set number. Prioritization module 380 constructs the multi-dimensional weights across the plurality of categories so as to determine the relationship between user 270 and a particular user. The user profiles and the social network graphs can be utilized to identify a relationship of user 270. For example, parent-child relationship, co-worker relationship, manager-subordinate relationship, business networks, professional hierarchy, close friends, etc. can be identified based on the aforementioned. It should be noted that the plurality of categories may pertain to a variety of subject matter including, but not limited to, social groups, work/career, industry, interests, affiliations, and the like. In some embodiments, construction of the vectors is supported by machine learning module 360 operating one or more long short-term memory (LSTM) and/or Siamese networks which build the vectors based on the social network graphs. Other embodiments may utilize one or more graph neural networks (GNNs). User 270 may also have the option to render a customized network which may be utilized for the social network graph generation process, in which the social network graphs are automatically analyzed in order for prioritization module 380 to determine the relative importance of other users to a selected user. It should be noted that social network graphs include nodes corresponding to users and edges indicating the relationships between the users, in which electronic communications exchanged between users are taken into consideration by prioritization module 380 to centrality and density of users across the vectors.

In some embodiments, prioritization module 380 supports the vector representing the relationships of user 270 with other users based on a user defined priority provided via user inputs on the centralized platform. For example, family relationships and/or relationships with other users that have a social range of 1 will be prioritized over all other relationships with user 270.

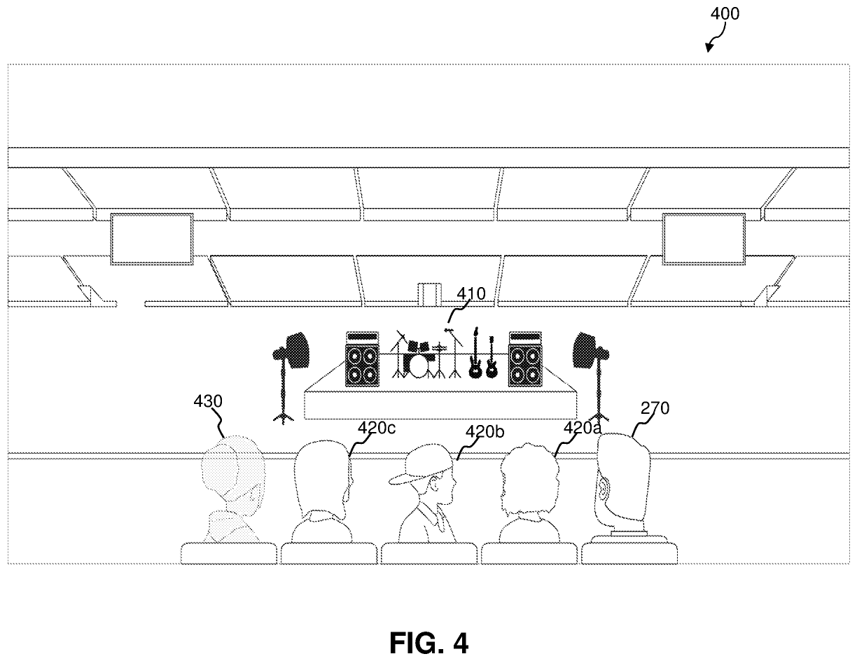

Referring now to FIG. 4, a virtual environment 400 is depicted, according to an exemplary embodiment. As depicted, virtual environment 400 includes a virtual event 410 being attended by user 270 along with social connections 420a-c associated with user 270 and a professional connection 430, each of which represented by avatars visualized within virtual environment 400 by visualization module 330. The avatars serve as not only visual representations of the users within virtual environment 400, but also references to the social network graphs in which users are visualized at virtual event 410 to user 270 based upon the relationship to user 270. For example, social connections 420a-c are vividly depicted to user 270 due to their direct social connection to user 270 at a social virtual event, while professional connection 430 is depicted based on their presence at a social virtual event with a fellow professional connection overlayed with a hollowed effect or any other applicable visual indicator configured to visualize a distinction among relationships (e.g., flashing, glowing, color-coded, etc.) known to those of ordinary skill in the art. In some embodiments, visual indicators are applied to users via prioritization module 380 based on various factors such as, but not limited to, level of influence a user given user has over user 270, context associated with the relationship of user 270 with a given user, amount of mutual connections, matching interests, relevant skills/competencies, affiliations, and the like. For example, professional connection 430 may have the visual indicator applied not only because of the professional relationship to user 270 (e.g., co-worker, colleague, mutual connection, etc.), but also because the social profile of professional connection 430 indicates that they are also an avid fan of the performer(s) associated with virtual event 410. In some embodiments, depiction of professional connection 430 is impacted based upon the preferences that user 270 has designated via inputs to the centralized platform. For example, professional connection 430 may not be visible to user 270 at virtual event 410 altogether if user 270 indicates that they do not wish to be able to see avatars associated with non-social connections within social virtual events.

It should be noted that the ability for user 270 to conceal visualization of designated avatars allows user 270 to generate a personalized setting within virtual environments. Therefore, user 270 is able to attend a social virtual event such as virtual event 410, an E-sport event, and the like virtually with their social friends without their presence at the social virtual event being visible to professional connection 430 who is also attending virtual event 410. In addition, the depiction of users within the virtual environment may be based upon the ranking assigned to the users via ranking module 370 based on the calculation of the weight associated with the user, in which prioritization module 380 ascertains the ranking of a user from ranking module 370 and takes into consideration various factors such as, but not limited to, the context of the virtual environment, the amount computing resources/bandwidth necessary to visualize each respective user at virtual event 410, etc. As a result, users are visualized to user 270 at virtual event 410 accordingly. For example, user 270 may have a multitude of social connections; however, social connections 420a-c are the highest ranked among the social connections due to their affinity for a particular performer associated with virtual event 410 derived from analysis of their respective user profiles resulting in prioritization module 380 prioritizing visualization of social connections 420a-c to user 270 at virtual event 410.

In some embodiments, weights are assigned across each of the plurality of categories, in which each social network graph will pertain to a different category. For example, a first social network graph for friends of user 270 comprising connections among a first set of nodes (i.e., friends) which are weighted based on the strength of the friendship (e.g., how long the friends have known each other, the geographic proximity between them, etc.). A second social network graph for work comprises connections among a second set of nodes (i.e., co-workers), in which the connections are weighted based on the strength of the relationship with the co-worker (e.g., frequency of interactions/communications, etc.), organizational hierarchy, amount of shared projects worked on together, and the like. In some embodiments, the centralized platform supports category-based searches, in which queries can span multiple social network graphs based on factors such as, but not limited to, social range, geographic location, strength of relationship, etc. For example, a query based on geographic location would span both the social network graphs for the first and second sets of nodes, in which a user in the virtual environment may overlap connections (i.e., a close friend who is a colleague that lives close to user 270).

In some embodiments, prioritization module 380 communicates with visualization module 330 in order to allocate a level of visibility to respective users based on one or more of the contexts associated with the virtual environment, current perspective of user 270, bandwidth associated with the virtual event, and the like. For example, depiction of social connection 420a to user 270 may be more visible than that of social connection 420b due to the fact that social connection 420a has a higher ranking than social connection 420b resulting in prioritization module 380 prioritizing depiction of social connection 420a at virtual event 410. The depiction of users in the virtual environment to user 270 may be directly correlated to social ranges associated with users defined by ranking module 370. For example, a friend of user 270 is allocated a social range of 1, a friend of a friend of user 270 is allocated a social range of 2, and so forth. As a result, visibility and other applicable visual indicators are applied to the avatars of users in the virtual environment based on the social ranges. User 270 may utilize the centralized platform to define which relationship types or sources are used when determining a social range between persons visualized in virtual environments. For example, user 270 may define a first social range limit for friends (or other social contacts), a second social range limit for business associates (or other business contacts), and a third social range limit for relatives (or other familial contacts). Additionally, user 270 may set various other criteria (e.g., geographic distance, type of virtual event, source of relationship, whether multiple relationships exist) when determining whether a social connection is considered in determining a social range between two or more persons.

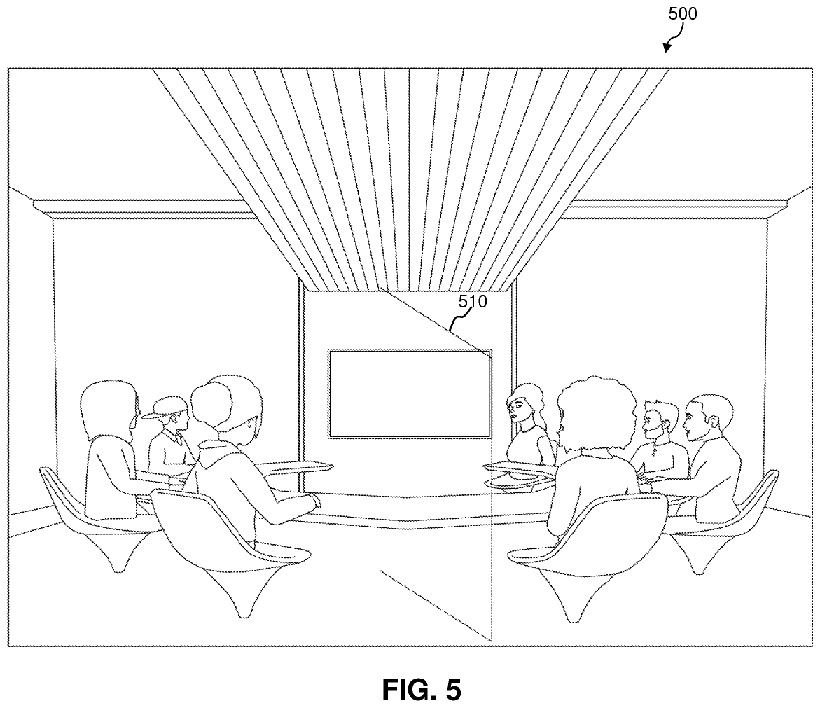

Referring now to FIG. 5, a virtual collaboration 500 is depicted within a virtual environment, according to an exemplary embodiment. Virtual collaboration 500 comprises a visual barricade 510 applied via visualization module 330 based on data derived from prioritization module 380. It should be noted that the data derived from prioritization module 380 is based on analyses of the constructed vectors. In a simple embodiment, social network graph G×(v,ε) (v nodes representing users and & representing relationships), vectors of each user which are generated based on an ascertained context derived from the analysis of the given virtual environment, resulting in calculated weights for each user being represented as a vector a across a plurality of categories based on the social network graph.

Thus, the constructed vectors are intended to represent respective users across the plurality of categories; however, corresponding user feature vectors and context-based vectors are within the scope of the disclosure. Vectors may all have the same dimensionality allowing the weights to be calculated for each user, and vectors may be optimized via the one or more machine learning models operating the feedback loops ensuring accuracy of ascertained contexts, relationships, rankings, prioritization of users in relation to user 270, and the like. Prioritization module 380 instructs visualization module 330 to generate visual barricade 510 based on detection of user 270 indicating a desire for a privacy room within virtual collaboration 500, therefore, preventing the ability of others within virtual collaboration 500 to see and/or hear user 270 along with designated users who user 270 wishes to be within the privacy room with them. In some embodiments, visual barricade 510 comprises a mirroring effect allowing users who are not within the privacy room and/or on the side of visual barricade 510 opposite of user 270 to know that visual barricade 510 exists within virtual collaboration 500. An important purpose of this functionality is to provide instances in which managerial users wish to assess productivity of subordinates within virtual collaboration 500 without detection by the subordinates.

In some embodiments, allocation of visual barricade 510 is applied to virtual environments automatically based on the rankings derived from analyzed social network graphs. Visualization of users within the virtual environment is performed via a prioritized depiction based on the ranking, in which users are presented to user 270 in the virtual environment according to their respective relationship to user 270. For example, a given virtual environment comprises user 270 with other users of various social ranges in which visual barricade 510 is applied to users who have beyond a threshold social range from user 270 (e.g., social range of two or more). As a result, the virtual environment depicted to user 270 only comprises users that have a social range of 1 associated with user 270. In other embodiments, users are depicted to user 270 in various sizes in which the more significant the relationship to user 270 the larger the associated avatar is depicted.

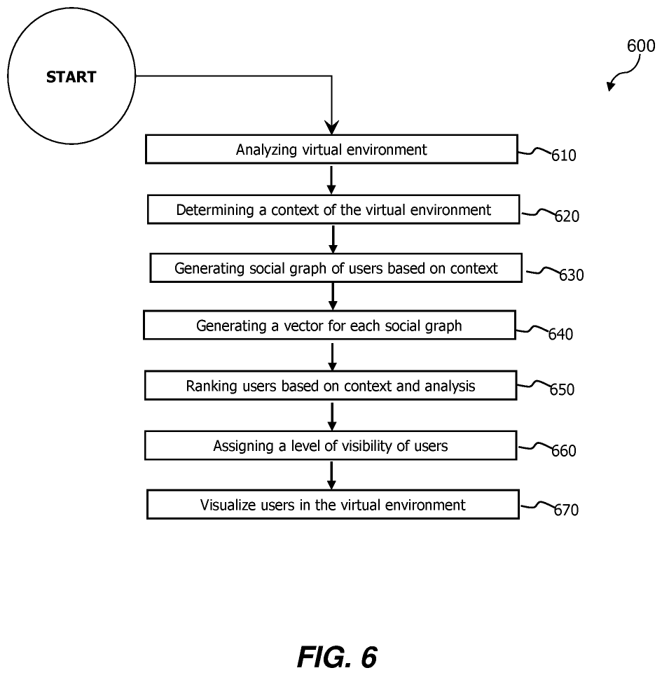

With the foregoing overview of the example architecture, it may be helpful now to consider a high-level discussion of an example process. FIG. 6 depicts a flowchart illustrating a computer-implemented process 600 for prioritizing users in a virtual environment, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 610 of process 600, virtual environment analyzer module 220 analyzes the applicable virtual environment. It should be noted that virtual environments, such as, but not limited to, metaverses, may require image/video analysis, parsing, tokenizing, 3D point cloud segmentation, virtual object detection, theme identification, or any other applicable VR/AR-based analysis mechanisms known to those of ordinary skill in the art. For example, environment analyzer module 220 may perform analyses on a virtual environment in order to ascertain a theme and/or topic associated with the virtual environment based on virtual objects and the type of users (e.g., performers, gamers, colleagues, etc.) within the virtual environment.

At step 620 of process 600, contextual module 310 determines the contextual data of the virtual environment based on the analyses. Contextual data may be ascertained from the dialogue, layouts/themes, and/or virtual elements integrated within the virtual environment such as, but not limited to, avatars, widgets, virtual objects, and any other applicable computer-generated objects and computer mediated reality incorporating visual, auditory, and other forms of sensory feedback. In a preferred embodiment, the contextual data establishes at least whether the virtual environment is a social virtual event (e.g., E-sports event, virtual concert, etc.) or a professional virtual event (e.g., work-related virtual collaboration, virtual industry-specific conference/seminar, etc.). In some embodiments, the ascertained contexts are factored into the ranking process along with the generating of the social network graphs process.

At step 630 of process 600, social network module 350 generates the social network graphs for users in the virtual environment. The social network graphs indicate relationships between the users based on the user profiles managed by user profile module 340. As previously mentioned, social network graphs indicate relationships between user 270 and other users in the virtual environment in which social network module 350 manages a series of users and relationships between those users as nodes (representing the users) and edges connecting the nodes (representing the relationships).

At step 640 of process 600, machine learning module 360 generates a vector for each user based on their respective social network graphs. By generating the vectors machine learning module 360 is able to calculate weights for each user by constructing a matrix of multi-dimensional weights representing relationships to the users across the categories. The constructed matrices include multi-dimensional weights calculated across different categories of relationships including, but not limited to, work, social, geographic, organization, affiliation, and the like. The calculation of the multi-dimensional weights allows ranking of users and visualization of users in the virtual environment based on the ranking to occur.

At step 650 of process 600, users are ranked by ranking module 370 based on the analyses of the virtual environment and ascertained context. Rankings dictate the visualization of users in the virtual environment to user 270, in which the relationship of users to user 270 in addition to the context determines whether a user is concealed in the perspective of user 270 and vice-versa. It should be noted that rankings may be based on a various factors including, but not limited to, frequency of communication with user 270 across applicable platforms (e.g., email, text, gaming, etc.), nature of relationship with user 270 (e.g., boss, best friend, relative, co-worker, etc.), geographic proximity, and the like. As a result of the ranking, visualization module 330 determines which users are concealed in relation to user 270 and vice-versa, in which the presentation of a particular user to user 270 in the virtual environment is subject to the determined relationship with user 270 derived from the user profile along with the ascertained contextual information. Each category has its own calculation module and outputs a value between 0 and 1, where 0 means not relevant, and 1 means extremely relevant. The generated vector will then have a multitude of dimensions <d1, d2, d3 . . . , dn> each measuring the relevance of all categories. Each calculation module has its own way of calculating this weight. For example, a friendship module calculates this weight by examining the social network graphs of user 270 and connection to a specific user, whereas a distance module can simply look up the ZIP code, figure out the longitude and latitude, and provide a rough distance estimation.

At step 660 of process 600, prioritization module 380 assigns a level of visibility of users. Prioritization module 380 communicates with visualization module 330 in order to allocate a level of visibility to respective users based on one or more of the contexts associated with the virtual environment, current perspective of user 270, bandwidth associated with the virtual event, and the like. It should be noted that concealing, shadowing, opaquing, mirroring, and any other applicable visual indicating mechanism known to those of ordinary skill in the art may be used to overlay visibility over an avatar in the virtual environment.

At step 670 of process 600, visualization module 330 visualizes the users in the virtual environment in accordance with the aforementioned. Visualization may be depicted in a variety of manners based on various factors, including, but not limited to, ascertained contextual information, detected context-based virtual objects, positioning of user 270 within the virtual environment, and the like. Furthermore, visualization module 330 supports manipulation of virtual objects and avatars within the virtual environment allowing user 270 to perform functions such as scale the size of virtual objects and avatars, move avatars at eye-level with user 270, apply virtual object effects to virtual objects and avatars, and the like. For example, it may be ascertained that a user in the virtual environment is a CEO in which they may be depicted in the virtual environment to user 270 as significantly bigger than everybody else in the virtual environment. In another example, a user in the virtual environment may be the sister of user 270 in which user 270 may comment “my sister drives me crazy”, and as a result the avatar associated with the sister is blown up significantly bigger than the surrounding virtual objects and avatars and spins around user 270 in the virtual environment.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-payment devices or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter payment device or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for prioritizing users in a virtual environment, the method comprising:
analyzing, by a computing device, a virtual environment;
determining, by the computing device, a context of a plurality of users associated with the virtual environment;
ranking, by the computing device, each user of the plurality of users based on the analysis and the context; and
visualizing, by the computing device, the plurality of users in a prioritized depiction within the virtual environment based on the ranking.

2. The computer-implemented method of claim 1, wherein ranking each user of the plurality of users comprises:
generating, by the computing device, a social graph for each user of the plurality of users based on the determined context; and
calculating, by the computing device, a weight for each user as a vector within a plurality of categories based on the generated social graph.

3. The computer-implemented method of claim 1, wherein analyzing the virtual environment comprises:
determining, by the computing device, a bandwidth requirement associated with the virtual environment for visualizing the plurality of users based on the ranking.

4. The computer-implemented method of claim 1, wherein visualizing the plurality of users comprises:
assigning, by the computing device, a level of visibility of each user of the plurality of users based on the ranking; and
depicting, by the computing device, users in the virtual environment based on the assigned level of visibility;
wherein the level of visibility determines the presentation of the users according to the perspective of each user of the plurality of users within the virtual environment.

5. The computer-implemented method of claim 2, wherein the social graph pertains to one or more of a social network, a business network, a professional hierarchy, and a user customized network.

6. The computer-implemented method of claim 2, calculating the weight for each user as a vector comprises:
constructing, by the computing device, a matrix of multi-dimensional weights representing a relationship among the plurality of users;
wherein each category of the plurality of categories comprises the social graph.

7. The computer-implemented method of claim 2, wherein the vector represents the relationship among at least one user and the plurality of users based on a user defined priority.

8. A computer program product for prioritizing users in a virtual environment, the computer program product comprising or more computer readable storage media and program instructions collectively stored on the one or more computer readable storage media, the stored program instructions comprising:
program instructions to analyzing a virtual environment;
program instructions to determine a context of a plurality of users associated with the virtual environment;
program instructions to rank each user of the plurality of users based on the analysis and the context; and
program instructions to visualize the plurality of users in a prioritized depiction within the virtual environment based on the ranking.

9. The computer program product of claim 8, wherein the program instructions to rank each user of the plurality of users comprise:
program instructions to generate a social graph for each user of the plurality of users based on the determined context; and
program instructions to calculate a weight for each user as a vector within a plurality of categories based on the generated social graph.

10. The computer program product of claim 8, wherein the program instructions to analyze the virtual environment comprise:
program instructions to determine a bandwidth requirement associated with the virtual environment for visualizing the plurality of users based on the ranking.

11. The computer program product of claim 8, wherein the program instructions to visualize the plurality of users comprise:
program instructions to assign a level of visibility of each user of the plurality of users based on the ranking; and
program instructions to depict users in the virtual environment based on the assigned level of visibility;
wherein the level of visibility determines the presentation of the users according to the perspective of each user of the plurality of users within the virtual environment.

12. The computer program product of claim 9, wherein the social graph pertains to one or more of a social network, a business network, a professional hierarchy, and a user customized network.

13. The computer program product of claim 9, wherein the program instructions to calculate the weight for each user as a vector comprise:
program instructions to construct a matrix of multi-dimensional weights representing a relationship among the plurality of users;
wherein each category of the plurality of categories comprises the social graph.

14. The computer program product of claim 9, wherein the vector represents the relationship among at least one user and the plurality of users based on a user defined priority.

15. A computer system for prioritizing users in a virtual environment, the computer system comprising:
one or more processors;
one or more computer-readable memories;
program instructions stored on at least one of the one or more computer-readable memories for execution by at least one of the one or more processors, the program instructions comprising:
program instructions to analyzing a virtual environment;
program instructions to determine a context of a plurality of users associated with the virtual environment;
program instructions to rank each user of the plurality of users based on the analysis and the context; and
program instructions to visualize the plurality of users in a prioritized depiction within the virtual environment based on the ranking.

16. The computer system of claim 15, wherein the program instructions to rank each user of the plurality of users comprise:
program instructions to generate a social graph for each user of the plurality of users based on the determined context; and
program instructions to calculate a weight for each user as a vector within a plurality of categories based on the generated social graph.

17. The computer system of claim 15, wherein the program instructions to analyze the virtual environment comprise:
program instructions to determine a bandwidth requirement associated with the virtual environment for visualizing the plurality of users based on the ranking.

18. The computer system of claim 15, wherein the program instructions to visualize the plurality of users comprise:
program instructions to assign a level of visibility of each user of the plurality of users based on the ranking; and
program instructions to depict users in the virtual environment based on the assigned level of visibility;
wherein the level of visibility determines the presentation of the users according to the perspective of each user of the plurality of users within the virtual environment.

19. The computer system of claim 16, wherein the program instructions to calculate the weight for each user as a vector comprise:
program instructions to construct a matrix of multi-dimensional weights representing a relationship among the plurality of users;
wherein each category of the plurality of categories comprises the social graph.

20. The computer system of claim 16, wherein the vector represents the relationship among at least one user and the plurality of users based on a user defined priority.
